(19) United States
(12) Patent Application Publication
(10) Pub. No.: US 2013/0262133 A1
(43) Pub. Date: Oct. 3, 2013

(54) Systems and Methods for Improving Communications and/or Relationships Between Hospitals and EMS Agencies

(71) Applicant: MEDMERGE SOLUTIONS, LLC, Troy, MI (US)

(72) Inventors: Chris N. Rodriguez, Kansas City, MO (US); David Bruce Bauer, Washington, MI (US); Kristin Butner, Country Club, MO (US); Glenn Garwood, Macomb Township, MI (US)

(73) Assignee: MEDMERGE SOLUTIONS, LLC, Troy, MI (US)

(21) Appl. No.: 13/783,457

(22) Filed: Mar. 4, 2013

Related U.S. Application Data
(60) Provisional application No. 61/619,272, filed on Apr. 2, 2012.

(51) Int. Cl. G06Q 50/22; G06Q 10/10

(52) U.S. Cl. CPC G06Q 50/22; G06Q 10/10
USPC 705/2

(57) ABSTRACT

According to various aspects, exemplary embodiments are disclosed of systems and methods for improving communications and/or relationships between hospitals and emergency medical service (EMS) agencies. In an exemplary embodiment, there is a web-based secure client application for allowing communications between hospitals and EMS agencies. In another exemplary embodiment, there is a web-based secure client application for creating a direct clinical data interface between hospitals and EMS agencies and allowing electronic transfer of information.

### CROSS-REFERENCE TO RELATED APPLICATION

This patent application is a U.S. nonprovisional patent application which claims priority to and benefit of U.S. provisional patent application No. 61/619,272 filed Apr. 2, 2012. The disclosure of the application identified in this paragraph is incorporated herein by reference in its entirety.

### FIELD

The present disclosure relates to systems and methods for improving communications and/or relationships between hospitals and emergency medical service (EMS) agencies.

### BACKGROUND

This section provides background information related to the present disclosure which is not necessarily prior art.

Sometimes, people with injuries or illnesses are unable to transport themselves to a medical care provider. In which case, emergency medical services (EMS) may then provide out-of-hospital medical care and transport to a hospital.

### SUMMARY

This section provides a general summary of the disclosure, and is not a comprehensive disclosure of its full scope or all of its features.

According to various aspects, exemplary embodiments are disclosed of systems and methods for improving communications and/or relationships between hospitals and emergency medical service (EMS) agencies, urgent care centers, and physicians. In an exemplary embodiment, there is a web-based secure client application for allowing communications between hospitals and EMS agencies. In another exemplary embodiment, there is a web-based secure client application for creating a direct clinical data interface between hospitals and EMS agencies and allowing electronic transfer of information.

Further areas of applicability will become apparent from the description provided herein. The description and specific examples in this summary are intended for purposes of illustration only and are not intended to limit the scope of the present disclosure.

### DETAILED DESCRIPTION

The inventors disclose herein exemplary embodiments of systems and methods for improving communications and/or relationships between hospitals and emergency medical service (EMS) agencies, urgent care centers, and physician offices. Advantageously, the inventors' disclosed systems and methods will help strengthen the connection between hospitals and emergency medical services, urgent care centers, and physician offices, thereby optimizing (or at least increasing) the efficiency of these organizations and improving the care of the patients that they serve.

In an exemplary embodiment, a website is configured to be operable as a portal to an actual application via a client login, which application will be a web-based secure client application available on devices that offer internet access such as mobile phones, smart phones, tablets (e.g., iPads, etc.), Mac-based computers, etc. The web-based application allows communications between medical care providers and emergency medical service agencies utilizing a secure client application with encryption technology.

Exemplary embodiments disclosed herein are configured so as to maintain patient privacy and security of their personal health information in compliance with HIPPA requirements and provisions. Accordingly, exemplary embodiments are configured to offer usability across various hardware platforms, internet browsers (e.g., Internet Explorer 6.0 and higher, Firefox, Safari, etc.) while maintaining strict security. Though faster internet access (e.g., broadband, cable, etc.) will afford more rapid functionality, slower speeds are also acceptable for operation. By way of example only, licenses for the inventors' products may be software-as-a-service (SAAS) type arrangements, with end-user license agreements or contracts signed by clients.

Profiles for users are position-specific. For example, clerical staff may not have access to all clinical data. Administrative users may be the only users with access to password management.

As recognized by the inventors hereof, hospitals are looking for more ways to increase their volume of patients. Pre-hospital agencies are typically seen as an accessible opportunity to increase patient numbers by increasing the number of ambulance transports to their hospitals. Solidifying the ties between the hospital and their agencies can produce more business for the hospital. This has been shown with efforts made through manual human resource attention to this issue, e.g., a hired EMS coordinator. There are times when patients simply have to be transported to the closest facility, or the patients have a desire for a particular hospital based on the location of their physician. But there are instances in which the patient refers to the judgment of the paramedic, which therefore provides some opportunity for enhanced volume if the paramedic feels there is an advantage to transport to a particular hospital. Enhanced quality improvement via this application is one such advantage.

After recognizing this, the inventors hereof sought to develop exemplary embodiments of systems and methods for strengthening the relationship between the hospitals and emergency medical service agencies and for providing valuable services that ultimately are beneficial to both. Accordingly, the inventors disclose a first exemplary embodiment in which a web-based secure client application creates an improved relationship between hospitals and EMS agencies. In this first exemplary embodiment, the web-based application allows communications between hospitals (or other medical facilities, medical care providers, or sites at which medical care is provided) and emergency medical service agencies utilizing a secure client application with encryption technology. A secured and encrypted bridge may be provided between the two entities (e.g., EMS and hospitals, etc.), which, in turn, may allow physicians and EMS personnel to become synergized into one complete emergent healthcare delivery system.

This first exemplary embodiment generally includes or is generally implemented with multiple modules, each one addressing various specific needs. Specifically, the modules include a Contact module, a Billing module, a Quality Assurance module, an Education module, and a MedConnex™ Electronic Messaging or Communication module. Note, however, alternative embodiments may include more or less than these five modules, such as by combining one or more of the modules, adding additional modules for other functionality, and/or eliminating one or more modules. In addition, exemplary embodiments also include methods relating to the use and operation of the various systems and modules disclosed herein.

The Contact module comprises a database having appropriate contact information for a multitude of health care providers and staff at both hospitals and EMS agencies. On the hospital side, the database may include contact information for emergency physicians, nurses, nursing administration, emergency department (ED) medical director, EMS coordinator, and billing personnel. In addition, other pertinent hospital personnel outside of the emergency department may be included in this database. Individuals from pharmacy, facilities, registration, and other medical service departments could be included such that EMS personnel may have the ability to contact them when warranted. On the EMS side, the database may include contact information for paramedics, chiefs, EMS education coordinators, billers, etc. This Contact module is generally usable for general communication purposes and not for patient information. But if patient information needs to be included in the communication, there will be a direct communication link to the secure and encrypted MedConnex™ module, thus facilitating integration between the Contact module and the MedConnex™ Electronic Messaging module or secure messaging system. In the event a paramedic has to leave urgently from a hospital, there will now be a facilitated way to communicate with the paramedic via this database. Users will be able to divulge contact information at their own discretion, and cell phone numbers, e-mail addresses, home phone numbers, etc. will be made proprietary based on individual choice. Business numbers (e.g., department or agency numbers, etc.) will be more obligatory.

The Billing module is a functional component that provides patient billing information derived electronically from the hospital's Admission/Discharge/Transfer (ADT) system. The Billing module is placed on one or more servers to be accessible to qualified EMS billing personnel.

Currently, the billing algorithm consists of the following steps: The paramedic transports the patient to the hospital, then typically waits in the emergency department while a face sheet containing patient billing information is printed out. This waiting time can be lengthy, especially if the patient needs urgent attention or if registration staff is behind due to volume surges. This wastes paramedic time, and the information is at times incorrect. Thus, inaccurate information is sent to the EMS billing entities, and the claim is rejected or delayed due to erroneous information. This creates significant rework and inefficiency, not to mention a waste of paramedic time out on the street transporting other patients. In addition, when the information is incomplete or incorrect, EMS agencies must contact the hospital and have the correct face sheet faxed to their agency. This potentially places both parties at risk for HIPAA (Health Insurance Portability and Accountability Act) concerns related to faxing.

With the inventors' systems and methods, there is provided a direct interface with the hospital ADT system. Data will be extracted and stored on secure servers. EMS billing staff then can sign-on via their personal account, and extract the necessary billing information for further billing purposes. In some agencies, it is the paramedic who is responsible for reconciling this correct billing information, which they will be able to do electronically through the inventors' systems. The profiles set for the users are dictated by their role and level of security. Only information necessary for performance of duties will be accessible to any particular profile. These profiles will also be defining which hospitals can be accessed and which EMS agencies are involved.

Data extracted preferably includes insurance name, policy number, group number, patient demographics, guarantor demographics, social security number, and any other specific item necessary for typical billing practices. Only staff with profiles allowing accessibility to this billing information will be able to view this data.

The inventors believe that this will greatly benefit both hospital and EMS agencies by creating a much more efficient system. For example, pre-hospital providers will no longer have to wait for registration services to input patient billing information and delay in-service times. Instead, there is an automated connection for EMS agencies to obtain complete, accurate, and HIPAA-compliant patient information. A decrease in hospital staff and EMS staff rework, abolition of difficulties with communication between the entities to reconcile billing information, and allowance of paramedics to immediately return to their ambulance for more transports highlight some of the advantages. In addition, potential HIPAA compliance issues may be avoided with the use of a more secure electronic system. Currently, names of patients sitting on a log sheet in EMS rooms are used to fax face sheets to EMS agencies that need updated information.

In regard to the Quality Assurance module, paramedics currently transport patients to hospitals after providing their care, and then rarely are given feedback information regarding the outcomes of their patients. Thus, there is a void in attempting to confirm the paramedics' ability to properly recognize and treat a number of different disease presentations. For example, did a paramedic treat a patient for heartburn when it really turned out to be a heart attack? Did a paramedic firmly believe a patient had pneumonia when the final diagnosis was a clot in the lung? A common theme among EMS providers is this lack of feedback for educational purposes since this clinical follow-up inherently helps paramedics improve their skills by allowing them a true understanding of patient outcomes.

The inventors' Quality Assurance module closes this loop, and is configured to provide automated, secure electronic feedback for paramedic review and quality assurance. This functionality allows emergency medical service personnel to see clinical diagnoses of patients they have cared for and transported. This technology will allow pre-hospital staff to hone their skills and change the way in which quality assurance is performed. This enhances paramedic skill set quality improvement by providing immediate information about transported patients. A review of history and physical exam elements can then elucidate missing or erroneous pathways that led to the misdiagnosis or impression. Lack of follow-up is similar to attempting to adjust the sights on a bow without seeing where the practice arrows hit the target. Knowledge is gained from seeing where the arrows struck (the final outcome), thereby allowing proper sight adjustments.

The inventors' Quality Assurance module will extract certain data elements from emergency department patients, place this data on secure servers, and have this available for end-users (e.g., paramedics, EMTs, etc.) that cared for the patient. These items may include such clinical data as EKG reports, cath lab reports, emergency physician notes, and discharge or admission diagnosis. Typically, much information is obtained via the emergency physician's notes. This would include the patient history of the present illness, past history, physical exam findings, test results, course in the emergency department, and final diagnoses. Some notes may vary from this format depending on the particular hospital or specific physician. Policies and procedures will be in place to assure that these individuals who use the system or web-based application limit their access to only the patients they transported. This would also be filtered via their specific log-on profile.

The follow-up information can be compared to the provider's own initial impression during transport. History and physical exam elements, as well as specific therapy given to the patient can be analyzed to provide clinical quality improvement. Ultimately, there will be provided a systematic process for quantifying the follow-up specifics. Continuous Education Units (CEUs—the EMS equivalent of continuing medical education for physicians) will be made available by performing the follow-up review and reconciliation. This will close the loop on a complete quality improvement system.

With regard to the Education module, most hospitals serve as “base hospitals” for their surrounding EMS agencies. Inherent in this obligation is the provision of educational lectures, clinical guidance, and direction in certifications and CEUs. This is typically done in a manual fashion without a formalized electronic platform. With the inventors' Education module, there is offered an electronic, web-based substrate for lecture scheduling, seminar detailed information, credential tracking, and ties to the follow-up CEU performance. Also, research projects and formalized quality improvement are typically responsibilities of the base hospital, and a platform for those activities will be provided in the Education module. For instance, analysis of the Quality Assurance module to determine particular clinical areas in need of attention can lead to focused educational efforts by creating a completely integrated quality assurance system with pertinent educational efforts. With the Education module, hospitals will have the ability to directly access the EMS community with classes and programs. Additionally, end-users may elect to keep track of CME offerings and also obtain credits for the electronic follow-up on patients.

The inventors' hereof recognized that inherent in the hospital/pre-hospital relationship is the continual need to communicate. These communications in many instances may need to include protected patient information, and thereby require a secure communication venue. Currently, many hospitals communicate with their EMS constituents via unsecured e-mail by faxing forms or reports, telephone correspondence, or land mail. These methods may be either insecure or inefficient. The MedConnex™ electronic communications module provides an electronic solution to this dilemma in that the MedConnex™ electronic communications module is an encrypted, HIPAA-compliant secure messaging system, which also allows for some limited attachment functionality. In this way, communication is instantaneous and secure. This is of paramount importance as HIPAA compliance becomes more scrutinized. The MedConnex™ electronic communications module may be accessed through a MedConnex™ home page, or through the Contact and Quality Assurance modules as well. In these latter instances, patient information or contact information is auto-populated into the MedConnex™ message, which is more efficient for the end-user.

The inventors hereof recognized that clinical EMS data in the pre-hospital setting is currently documented in both paper and electronic formats, depending on the particular EMS agency and whether or not they have purchased an electronic medical record (EMR) system. This pre-hospital data is absolutely crucial for hospitals in regard to continuity of care, specific pre-hospital data, and accreditation efforts. Regarding continuity of care, ED physicians and nurses rely on the EMS reports to find out what occurred in the field, analyze clinical elements, and treatment response. Also, specific pre-hospital data is used for proper hospital billing code levels. And, accreditation efforts (e.g., chest pain, stroke, trauma, congestive heart failure, etc.) require very complete and specific pre-hospital data.

After recognizing this, the inventors hereof sought to develop and disclose herein a second exemplary embodiment in which a web-based secure client application creates a direct clinical data interface between hospitals and EMS agencies, which allows electronic transfer of the information. In this second exemplary embodiment, the web-based application allows communications between hospitals (or other medical facilities, medical care providers, or sites at which medical care is provided) and emergency medical service agencies utilizing a secure client application with encryption technology.

This second exemplary embodiment generally includes or is generally implemented with multiple systems or modules, each one addressing various specific needs. Specifically, the modules include a Billing module, various Clinical modules, a Student module, Pharmacy Management module, an Equipment Exchange module, and an Electronic Forms module. Note, however, alternative embodiments may include more or less than these modules, such as by combining one or more of the modules, adding additional modules for other functionality, and/or eliminating one or more modules.

In regard to the Billing module, currently when patients are seen in the emergency department, the hospital uses “Level of Service” coded billing for reimbursement for the care rendered in the emergency department. This is separate from the emergency physician's bill. In this level billing scheme, reimbursement is tied to the degree of complexity and resource utilization. A critical component that factors into calculating the level of service given is the pre-hospital care. If patients are given specific advanced care by EMS personnel, this raises the complexity and possibly the “level” of billing. Currently, defining these pre-hospital parameters is done on a manual, chart review basis. The inventors' Billing module captures electronically the specific pre-hospital data utilized in the billing scheme and creates a report that highlights the particular degree of pre-hospital care as it relates to hospital billing. Ultimately, this data may be integrated into the actual billing application used by the hospital. Drugs given, intravenous access, procedural data, and clinical impressions may also be extracted from the EMS data and integrated into this Billing module.

The Clinical modules may include various clinical modules depending, for example, on the particular application, hospital, etc. For example, there may be included a Chest Pain module as described in Example A below. A Stroke module may also be included that is similar in concept as Chest Pain module described herein. The Stroke module follows Joint Commission Accreditation guidelines with specific pre-hospital elements. The Stroke module demographics include times, numbers of patients, turnaround times, etc. The clinical elements of the Stroke module include Cincinnati Stroke Scale, other assessment tools, and clinical parameters.

A Congestive Heart Failure module may emulate the other clinical modules in their format. Accreditation parameters are accounted for in an electronic format, where interaction between the hospital and EMS agency occurs. Like the Chest Pain module, formalized relationships between the hospital and its EMS constituents will be highlighted through specific fields in the Congestive Heart Failure module. In addition, metrics including treatment modalities, and pre-hospital assessments will be incorporated into this particular component.

Since congestive heart failure is a condition that warrants very particular attention due to issues regarding readmission rates, pre-hospital treatment and assessment parameters will be extremely important for hospitals in their readmission prevention efforts.

A Trauma module may emulate the chest pain accreditation module, although typically more involved with requirements for reporting on a reimbursement and government funding basis. Currently, innumerable man-hours are spent manually mining charts for completion of trauma care reporting data. The inventors' Trauma module allows automated data capture of pre-hospital elements pertinent to trauma care and data reporting.

A Sepsis module may also be included. As the treatment of sepsis has been scrutinized in the recent past, earlier intervention has been found to be beneficial to patients in cases of severe sepsis. Early fluid administration, such as in the pre-hospital arena, may improve outcomes for a subset of septic patients. The inventors' Sepsis module allows for clear delineation of treatments given in context with appropriate management of the severely septic patient. Data gathering is focused toward identifying the specific modalities initiated in the field.

Details that may be included in a Student module are provided below in Example B. The Student module may be independent of EMS field data and may create a management system for EMS students (e.g., Paramedics, EMTs, etc.) that perform clinical rotations at hospitals. The Student module may also be extrapolated for nursing students. Essentially, the Student module places the aspects of the rotation and the relationship of the hospital with the school in one electronic application. Scheduling, credentials, background checks, ID, contact information on both sides, news and notices, hospital mapping, rotation expectations, performance evaluation, etc., may be included as part of this application Student module. By way of example, the hospital and schooling agency may be given software-as-a-service access to a remote-hosted, web-based application.

In regard to the Pharmacy Management module, currently paramedics exchange drugs and drug boxes with hospitals in a paper world. Exchanges including narcotics and other important drugs are documented on paper and then pharmacies reconcile these drugs electronically at a later time. This is also true for EMS agencies. The inventors' Pharmacy Management module categorizes drug types and allows electronic documentation of exchanges. Also, a hospital mapping system may be in place to route paramedics to the pharmacy department.

On many runs, equipment such as backboards, linen, Kendrick Extrication Device (KED) boards and other equipment and supplies are exchanged. The inventors' Equipment Exchange module provides an electronic format to manage this.

Typically, all forms required for exchanges of information between hospitals and EMS agencies are kept in paper format. If they are needed in the hospital record, they must then be scanned in. The inventors' Electronic Forms module provides electronic formats for these forms, which can then be printed or sent in electronic format. Examples include transfer forms, necessity forms (Medicare), Nursing home transfer forms, EMTALA (Emergency Medical Treatment and Active Labor Act) reference, etc. Ultimately, an account can be obtained from nursing homes which will integrate into the hospital record.

The inventors' also recognized that current pre-hospital electronic medical records (EMRs) are simple data repository applications without integration or clinical decision support. These systems do not provide optimized patient care due to the lack of these elements. After recognizing this, the inventors hereof sought to develop and disclose herein a third exemplary embodiment that allows pre-hospital providers to harness technology and tools for hospital-based practitioners, which will facilitate real-time connection between pre-hospital and hospital caregivers. The inventors disclose a comprehensive, multifunctional EMS electronic medical record with device integration, robust clinical decision support with disease specific algorithmic guidelines and county-specific protocol delineation, and multimedia capabilities for telemedical applications. In this third exemplary embodiment, a web-based secure client application may be used to allow a real-time connection between pre-hospital and hospital caregivers utilizing a secure client application with encryption technology.

Device inputs, such as weight, temperature, or blood pressure measurements will be integrated into the software and utilized for clinical decision support—drug dosing, alerts, etc. Other examples of clinical decision support include the following:

1) Relevant data presentation—such as details of how to give an epinephrine injection just before administration;

2) Documentation templates—there could be complaint specific documentation templates that may present relevant input data suggestions;

3) Alerts and reminders—e.g., do not give morphine if patient has morphine allergy; and

4) Protocol pathway support—details county specific protocol for that clinical issue.

In addition, documentation fields for time-sensitive metrics via simple voice commands or mouse clicks will be available. For example, the time of EKG performance and time of aspirin administration could be input by the above means. This may be integrated into a portable monitor/defibrillator such that the functionality is portable and capable of being carried to the patient's side. Decision support and telemedicine functions will be available while the patient is being treated in the home or other patient location. In addition, since having both hands available while working on patients is crucial, the inventors' EMR has the capacity for voice activation and control, and voice recognition for hands-free dictation. This allows real-time input while actively working with both hands.

The inventors' exemplary embodiments disclosed herein may include one or more (and preferably all) of the following security provisions:

Hosting—secure, trusted site with HIT (Host Integration Tool) experience (e.g., data stored at a secure and HIPAA 5020 compliant commercial health information systems hosting site);

Business agreements—with hosting, hospitals, EMS agencies;

Security policies and procedures—HIPAA, password management, breach policies and notifications, downtime policy, data integrity policy, etc.;

Detailed profiles for technical support (e.g., Medmerge) staff, hospital end-users, and EMS end-users; and/or

Appropriate encryption utilization.

As disclosed above for the second exemplary embodiment, a web-based application creates a direct clinical data interface between hospitals and EMS agencies, which allows electronic transfer of the information. This second exemplary embodiment generally includes or is generally implemented with multiple systems or modules for addressing various specific needs, such as a Billing module, various Clinical modules (e.g., a Chest Pain module, etc.), a Student module, Pharmacy Management module, an Equipment Exchange module, and an Electronic Forms module.

Examples A and B below provide details that may be included in a Chest Pain module and a Student module, respectively. Note, however, alternative embodiments may include more details, less details, and/or different details than what is provided in Examples A and B. Accordingly, Examples A and B are provided for purpose of illustration only and not for purposes of limitation.

### Example A

### Chest Pain Module

When hospitals are seeking accreditation for becoming a chest pain center, a whole host of processes need to be put into place. The Society of Chest Pain Centers provides an exhaustive guide for all of the elements that need to be implemented. There are essentially three categories of processes that are required. The first is the establishment and documentation of a formal relationship between the hospital and the EMS agencies. The second set of processes includes a formal outreach program between hospitals and EMS agencies that incorporates education and a quality assurance initiative. The third category of stipulations involves the development and continuation of metrics that assess quality and patient care in the pre-hospital setting.

All of these elements can be very difficult to track and report for accreditation. The inventors' disclosed Medmerge product solves this data acquisition and management problem. The inventors' Medmerge solution not only integrates pre-hospital treatment and assessment data with the inventors' Medmerge interface, it also creates usable reports both on the pre-hospital and hospital side that satisfy accreditation requirements. The following paragraphs delineate specifics of this example chest pain accreditation module of the phase 2 product, which may also be referred to as the second phase or second exemplary embodiment.

In this first section, a systemized way of documenting a relationship between the hospital and its EMS constituents with specific relationship to chest pain is established. Accredited hospitals are required to have regular joint meetings at least quarterly with EMS agencies. As part of this application, the parameters of these meetings will be monitored through the program. Because this second phase of the Medmerge product is integrated with Medmerge (which is also referred to as the first phase or first exemplary embodiment), the contact database will be in place for hospital EMS coordinators to contact each of the EMS agencies and individual paramedics. They can now be informed of these joint meetings, and will have the capacity with this program to electronically enroll for these meetings. The ability to know who is going to attend allows planning for food, automated sign-in sheets, and tabulation of attendance. These meetings may also include lectures, which would provide continuation education unit (CEU) credit for those in attendance. In this circumstance, CHIT sheets may be pre-printed and ready for distribution with this electronic pre-registration. Other specifics of these meetings may be included in this application as well. Electronic documentation of meeting agendas and meeting minutes may be included for accreditation purposes. In addition, mapping of the location as well as internal hospital mapping to locate the conference room may be included.

To become accredited in chest pain, hospitals are mandated to perform regular case reviews of chest pain patients in conjunction with pre-hospital EMS agencies. This application allows integration and extraction of pre-hospital data elements such that the specifics of a transport of a chest pain patient can be accumulated into one place. To complete a case review, the phase 1 product (also referred to as Medmerge Foundations) provides the clinical outcome elements from the hospital visit. Therefore, pre-hospital transport and final patient outcome can be reviewed from the electronic extraction of these data points. Since not all patients with chest pain have a cardiac etiology as the cause of their pain, other diagnoses are important to consider with the chest pain patient.

A “case review template” can be included to provide a reporting mechanism for accreditation. This template could include the previously mentioned elements, and also include the meeting specifics as mentioned in the previous section on joint meetings. Lastly, this could also include fields that delineate the issues identified and the next steps to be taken to correct any deficiencies. This standardized template could then be viewed by quality assurance personnel or other administrators, as well as caregivers involved in these cases.

Because part of this accreditation involves hospitals collaborating with EMS agencies in regards to quality of care, the refinement of pre-hospital processes can be accomplished with a joint effort between these organizations. Every minute step in pre-hospital care can be dissected utilizing a formal LEAN or six sigma process analysis methodology. A basic value-stream map template may be provided to organize process analysis and improvement. Issues raised together with mitigation strategies can be documented and distributed via this portion of the application. This structured approach to this particular required accreditation element will create better efficiency for hospitals and pre-hospital organizations.

The next section of this example Medmerge solution facilitates a required creation of a formal written charter. This document delineates the goals and objectives, as well as the proposed procedure for accomplishing the tasks of this mutual arrangement. A sample template that includes typical charter elements will be included.

Patients who are actively having a heart attack as seen on an EKG done in the field have two major options for therapy. One option is to receive a clot-busting drug called tPA. Another option is to have an emergent cardiac catheterization with mechanical opening of the coronary artery with percutaneous coronary intervention (PCI). Since providing emergent catheterization services requires a necessary amount of available on-call resources, not all hospitals can provide this capability. Due to its effectiveness and relative lack of adverse effects, PCI has become the preferred treatment modality for ST elevation myocardial infarctions (STEMI). It has been shown that administering tPA if PCI is unavailable is beneficial until PCI can be performed.

Therefore, EMS agencies need specific guidelines for transport of STEMI patients, since the choice would be dependent on distance and PCI verse tPA capabilities. The inventors' Medmerge product or system provides a template for defining this algorithm based on these exact parameters and the decisions made by the supervising entity. This may also be augmented by incorporating a global positioning or cellular location-mapping method into the Medmerge product, as well as a location-specific database of local hospitals with capabilities for creating a more automated algorithm.

Communication between EMS agencies and hospitals typically occurs through radios dedicated to this function. The Society of Chest Pain Centers, through its accreditation, mandates that hospitals spell out their plan for the testing and maintenance of their EMS communication systems. The inventors' Medmerge application or system will provide fields for documentation of this system.

Many EMS agencies have the ability to perform 12 lead EKGs in the field, thereby allowing rapid identification of those patients suffering an acute myocardial infarction. Paramedics may rely on their own interpretation of these EKGs, or in some instances have the capability of transmitting these EKGs to the base hospital. The chest pain accreditation requires that hospitals and EMS agencies work together to make this an accurate and effective system. EKG acquisition, transmission, and interpretation all need to be of maximal effectiveness in order for this procedure to work. The Medmerge chest pain accreditation module manages this quality assurance system for pre-hospital EKG performance. Testing and maintenance of EKG equipment can be monitored in this example Medmerge chest pain module.

Aspects of the system's equipment can be documented here. In addition, EMS interpretations can be compared to physician interpretations and a solid quality assurance initiative can be based on those results. EKG interpretation courses can be provided by the hospital, and specifics of these courses can be documented in the Medmerge chest pain module. In addition, competency for EKG interpretation can also be documented and managed in this module.

One goal of the chest pain accreditation is to limit the numbers of patients with chest pain that are diverted from hospitals due to overcrowding. Specific policies can be spelled out in this example Medmerge Chest Pain module that pertain to criteria for overriding a diversion status. The number of chest pain patients diverted and also those received during diversion hours can be tracked as well.

A section may also be provided that details a fibrinolytic protocol according to ACC/AHA guidelines. The Medmerge Chest Pain module can also accommodate information regarding EMS dispatch. Names of personnel, attendance at meetings, licensure, and dispatch protocols can be tabulated within this part of the module to ensure their active participation in protocol development.

The next section of this example Chest Pain module highlights other items that emphasize the official relationship between the hospital and EMS organizations. Such things as social events, scientific studies, and attendance at county meetings can be documented here.

Because effective management of the STEMI patient is crucial for a chest pain center, the Society of Chest Pain Centers mandates that specific parameters be explicitly delineated for a hospital seeking accreditation. The Medmerge solution encapsulates this process management in this example Chest Pain module.

After a reperfusion strategy has been mapped out as seen in the corresponding section of this application, the exact processes that will occur when transporting a heart attack patient to the hospital will be described in this section. Such issues as pre-hospital activation of the catheterization laboratory, whether or not a patient stops in the emergency department or goes straight to the catheterization laboratory, and the arrival processes that occur in the hospital need to be agreed upon and documented in this particular section, possibly in algorithmic format. Monitoring of catheterization laboratory activations, especially from the field, can be tabulated here for further review. Any false positive activations can then be readily available for quality assurance.

Because longer transports of STEMI patients may be best accommodated by helicopter service, the exact parameters of when to use these services and a listing of these helicopter agencies will be included in this section. Ultimately, a real-time guide of the status of these helicopter agencies based on weather conditions will be included.

The following paragraphs describe the portion of this example Medmerge chest pain accreditation module that highlights the specific hospital outreach to EMS agencies.

STEMI drills that involve both the hospital and pre-hospital organizations will be documented in this first part of this portion of the Medmerge Chest Pain module. Certain elements such as dates and times of events, personnel and agencies involved, scripts of the drills themselves, action items, and lessons learned will be part of this STEMI drills management documentation.

Any funding or grant opportunities will be described in its own place here in the application.

The next item in this category of facility outreach to EMS agencies involves educational efforts provided by the hospital. This includes goals and objectives of the educational program, the hospital strategic plan for this education, and stratification of the educational needs by specific personnel. EMT basic personnel may need different education then paramedics, for instance. Examples of these statements will be provided. Also included in this section are specifics of the individual educational offerings. On site hospital rotations may also be included in this education section. This would include rotations through the catheterization laboratory, with on-line scheduling, picture ID, background checks, internal hospital mapping, and question and answer capabilities through the MedConnex™ technology including a secure Electronic Messaging module or system. Tabulation of continuing education units, and any teaching materials distributed to EMS agencies is also included here.

Ambulance ride-alongs by cardiologists, ED (Emergency Department) physicians, and personnel will be documented and scheduled in this section as well.

Another field(s) is provided to show a summary of a joint research project conducted by the hospital and EMS agencies.

In the following section, metrics regarding pre-hospital patient care are documented. This would include times for: 1) patient's pain to EMS call; 2) 911 call to first EKG; 3) First point of medical contact to 1st EKG; 4) First point of medical contact to cath lab activation; 5) First point of medical contact to reperfusion; and 6) Door-to-door-to-balloon. Percentage of cath lab activations of correctly interpreted EKG's, and any other pre-hospital measures may also be recorded here.

A section for presentation of process improvement tools (e.g., LEAN or six sigma methodology) will be available here. A separate section to detail any site-specific innovation will be provided.

These parameters described in this example chest pain module may be essentially replicated, with adjustments for specific clinical issues, for other clinical modules, such as CHF, trauma, sepsis and atrial fibrillation, etc. These other clinical modules would follow the disease specific requirements as set forth by the accrediting body.

### Example B

### Student Module or Student Management System

Individuals learning to become EMT providers and paramedics are required to rotate through various hospital venues to complete their education. This might include the emergency department, OB/GYN floor, medical/surgical floors, and other departments. Currently hospitals accommodate EMS learning institutions, such as community colleges and private EMS schools by accepting these rotators. The management of these rotations is currently manually performed in most institutions, and is inefficient, scattered, and at times unsafe with limited verification of backgrounds. Typically, there are very few hospital personnel working alongside these rotators who know who they are and what is expected of them.

As disclosed above, the inventors' Medmerge product or system includes a web-based application that will manage electronically the aspects of these educational on-site rotations. Both hospital and participating teaching organizations would acquire or purchase the Medmerge product. The Medmerge product would also be integrated with other hospital-based Medmerge solutions, such as those disclosed herein. The features of this may include:

1) Password-protected sign-on for users.

2) A contact database for both school staff and hospital management staff. This facilitates telephone and email correspondence for expedited communication.

3) On-line scheduling of rotations. This has a calendar type format with open or unavailable slots for student scheduling. This would also provide students a schedule of their rotations with times, locations, and contact person information. Also contained in these fields would be links to internal hospital mapping for locating the specific department.

4) Hospital policy/procedures for rotating students. This would include HIPAA provisions and summary training with check-off for completion of this HIPAA module.

5) Badge acquisition information.

6) Daily sign-in and sign-out with times.

7) Agenda/expectations for rotation.

8) Credentials of EMS student including picture/photo ID, passing of background check, level of training, expectant learning goals, and procedures required to perform.

9) Logging of procedures.

10) Student evaluation including check off on procedures performed, supervisor evaluations of student, and certificate printing.

11) Facilitated communication via MedConnex™ technology including a secure Electronic Messaging module or system.

12) This will be extrapolated to nursing schools, pharmacy schools, and other schools with rotating students.

13) This would also be extrapolated for EMS students who are performing on-ambulance rotations, and this product would interface with the EMS Medmerge product (Phase 1 product).

It should be noted that although various exemplary embodiments of the disclosure are described with reference to hospitals and EMS agencies, the inventors' exemplary embodiments may be used with other types of medical facilities, medical care providers, or sites where medical care is provided. For example, an exemplary embodiment may include methods and systems that are configured to help communications between EMS agencies and medical care providers that are not located at a hospital, such as urgent care centers and/or outpatient surgery centers.

Depending on the particular application, end users, medical care providers, one or more individual modules, elements, intended or stated uses, or features of a particular embodiment (e.g., the first, second, or third embodiment, etc.) are generally not limited to that particular embodiment, but, where applicable, may be combined with one or more (or all of) the individual elements, intended or stated uses, or features of another embodiment. Although the first, second, and third embodiments are described separately herein, any two or more (or all) of the first, second, and third embodiments may be combined into a single embodiment or implementation. For example, the first and second embodiments may be combined, implemented and used together in the same system or method. As another example, the first and third embodiments may be combined, implemented and used together in the same system or method. As yet another example, the second and third embodiments may be combined, implemented and used together in the same system or method. As a final example, the first, second, and third embodiments may all be combined, implemented and used together in the same system or method.

The various modules disclosed herein are illustrative of the aspects of the present disclosure and need not be characterized as such. For example, one or more of the various modules may be combined, or may be further subdivided into separate modules or routines and/or subroutines. In addition, computer readable program code may comprise more modules or components than those disclosed herein. Furthermore, computer readable program code for implementing one or more modules disclosed herein may be a stand-alone application, a plug-in module, otherwise combined with an existing application and/or operating system, etc. Computer readable program code for implementing one or more modules disclosed herein may be conventionally programmed using any of a wide range of suitable computer readable programming languages that are now known in the art or that may be developed in the future. Computer readable program code for implementing one or more modules disclosed herein may include one or more functions, routines, subfunctions, and subroutines, and need not be combined in a single package but may instead be embodied in separate components. Computer readable program code for implementing one or more modules disclosed herein may be integrated into an operating system or an application, such as a “software application” which may be interpreted broadly and/or take many forms, including but not limited to source, object, and/or executable code that can include and/or refer to a plurality of objects, modules, libraries, services, etc., and that can be stored, distributed, downloaded, combined and/or accessed in many different ways. Computer readable program code for implementing one or more modules disclosed herein may reside at one or more network devices, such as an administrator terminal, a server, etc. Disclosure of computer readable program code for implementing one or more modules disclosed herein is not believed necessary, as one skilled in the programming arts should be able to generate such code without undue experimentation given the disclosure found herein. Accordingly, explicit details associated with programming of computer readable program code for implementing one or more modules disclosed herein are not provided herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials may be used, etc.) and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are examples in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for allowing communications between hospitals and emergency medical service (EMS) agencies, the system comprising a web-based secure client application configured to be operable on devices with internet access for allowing communications and utilizing encryption technology whereby patient privacy and security of personal health information is maintained, wherein the system further comprises one or more of:
a Contact module including a database having contact information for hospital personnel and EMS personnel; and/or
a Billing module configured to be operable for electronically extracting patient billing information from a hospital Admission/Discharge/Transfer (ADT) system; and/or
a Quality Assurance module configured to be operable for electronically extracting clinical data about one or more emergency department patients for review by EMS personnel that provided care to and/or transportation for the one or more emergency department patients; and/or
an Education module including an electronic platform for scheduling and/or tracking of education; and/or
an Electronic Communication module configured to be operable for providing secure, encrypted electronic communications between hospitals and emergency medical service (EMS) agencies.

2. The system of claim 1, wherein the system includes each of the Contact module, the Billing module, the Quality Assurance module, the Education module, and the Electronic Communication module.

3. The system of claim 1, wherein the system includes a website operable as a portal to the web-based secure client application via a client login.

4. The system of claim 1, wherein the system includes the Electronic Communications module, which comprises an encrypted, HIPAA-compliant secure messaging system configured to be operable with attachment functionality and for allowing secure and substantially instantaneous communication.

5. The system of claim 4, wherein:
the system includes the Contact module and the Quality Assurance module; and
the Electronic Communications module is accessible through a home page, the Contact module, and the Quality Assurance module, whereby patient information and/or contact information may be auto-populated into a message sent utilizing the Electronic Communications module.

6. The system of claim 1, wherein the system includes:
the Contact module;
the Electronic Communication module; and
a link between the Contact module and the Electronic Communication module for allowing secure and encrypted communication of patient information to the EMS personnel.

7. The system of claim 1, wherein:
the system includes the Billing module; and
the Billing module includes an interface for extracting data from a hospital Admission/Discharge/Transfer (ADT) system for storage on one or more secure servers to be accessed by EMS billing staff that sign-on via a personal account.

8. The system of claim 1, wherein:
the system includes the Quality Assurance module; and
the system is configured such that the extracted clinical data is placed on one or more secure servers and such that a user's access is limited to the extracted clinical data of patients to which the user provided care and/or transported as filtered via a log-on profile of the user.

9. The system of claim 1, wherein:
the system includes the Education module; and
the Education module includes an electronic, web-based substrate for lecture scheduling, seminar detailed information, credential tracking, ties to the follow-up Continuous Education Units, research projects, and formalized quality improvement

10. The system of claim 1, wherein:
the system is configured to maintain patient privacy and security of personal health information in compliance with HIPPA (Health Insurance Portability and Accountability Act); and/or
the system is configured to offer usability across various hardware platforms and internet browsers while maintaining strict security; and/or
profiles for users are position-specific and/or set depending on user role and level of security.

11. A system for allowing communications between hospitals and emergency medical service (EMS) agencies, the system comprising a web-based secure client application configured to be operable on devices with internet access for allowing communications and utilizing encryption technology whereby patient privacy and security of personal health information is maintained, where the system is configured to be operable for providing secure, encrypted electronic communications between hospitals and emergency medical service (EMS) agencies.

12. The system of claim 11, wherein:
the system further includes a database having contact information for hospital personnel and EMS personnel and/or an electronic platform for scheduling and/or tracking of education; and/or
the system is further configured to be operable for electronically extracting patient billing information from a hospital Admission/Discharge/Transfer (ADT) system and/or electronically extracting clinical data about one or more emergency department patients for review by EMS personnel that provided care to and/or transportation for the one or more emergency department patients.

13. The system of claim 11, wherein the system includes an encrypted, HIPAA-compliant secure messaging system such that patient privacy and security of personal health information is maintained in compliance with HIPPA (Health Insurance Portability and Accountability Act).

14. The system of claim 11, wherein:
the system further comprises an emergency medical services (EMS) electronic medical record which is comprehensive and multifunctional;
the EMS electronic medical record is configured with device integration, robust clinical decision support with disease specific algorithmic guidelines and county-specific protocol delineation, and multimedia capabilities for telemedical applications; and
the EMS electronic medical record is further configured with device inputs that are integrated and utilized for clinical decision support;
whereby the EMS electronic medical record facilitates real-time connection between pre-hospital and hospital caregivers.

15. The system of claim 14, wherein the EMS electronic medical record includes documentation fields for time-sensitive metrics available via voice commands and/or mouse clicks.

16. The system of claim 14, wherein:
the EMS electronic medical record is integratable into a portable device capable of being carried to a patient's side, thereby allowing decision support and telemedicine functions available onsite where the patient is being treated; and
the EMS electronic medical record is configured with voice activation and control, and voice recognition for hands-free dictation, thereby allow hands-free real-time input while actively working with both hands.

17. A system for allowing electronic transfer of information between hospitals and emergency medical service (EMS) agencies, the system comprising a web-based secure client application configured to be operable for creating a direct clinical data interface between hospitals and emergency medical service agencies for electronic transfer of information and utilizing encryption technology whereby patient privacy and security of personal health information is maintained, wherein the system further comprises one or more of:
a Billing module configured to be operable for electronically capturing pre-hospital data utilized in a billing scheme of a hospital and for creating a report that highlights a particular degree of pre-hospital care as it relates to hospital billing, which captured pre-hospital data is integratable into an actual billing application used by the hospital; and/or
a Clinical module configured to account for accreditation parameters in an electronic format where interaction between the hospital and EMS agency occurs and where formalized relationships between the hospital and EMS constituents are highlighted through specific fields in the Clinical module, the Clinical module configured to be operable for automated data capture of pre-hospital elements pertinent to care and data reporting; and/or
a Student module configured to be operable for electronically managing on-site rotations by students, where aspects of the on-site rotations and relationship of the site where the rotations occur and schooling agency are in an electronic application; and/or
a Pharmacy Management module configured to be operable for categorizing drug types and allowing electronic documentation of exchanges; and/or
an Equipment Exchange module configured to be operable for providing an electronic format to manage exchanges of equipment and supplies between EMS runs; and/or
an Electronic Forms module configured to be operable for providing electronic formats for forms required for exchanges of information between hospitals and EMS agencies, which forms may be printed or sent in electronic format.

18. The system of claim 17, wherein the Clinical modules include a Chest Pain module, a Stroke module, a Congestive Heart Failure module, a Trauma module, and a Sepsis module.

19. The system of claim 17, wherein:
the Student module comprises a remote-hosted, web-based application; and/or
the Student module includes one or more of password-protected sign-on for all users, a contact database for school staff and hospital management staff, on-line scheduling of rotations and links to internal hospital mapping for locating a specific department, hospital policy/procedures for rotating students, badge acquisition information, daily sign-in and sign-out with times, agenda/expectations for rotation, credentials of EMS student including picture/photos ID, passing of background check, level of training, expectant learning goals, and procedures required to perform, logging of procedures, student evaluation including check off on procedures performed, supervisor evaluations of student, and certificate printing, and/or facilitated communication via secure electronic messaging module.

20. The system of claim 17, wherein the system includes an encrypted, HIPAA-compliant secure messaging system such that patient privacy and security of personal health information is maintained in compliance with HIPPA (Health Insurance Portability and Accountability Act).

21. The system of claim 16, wherein the system includes each of the Billing module, the Clinical module, the Student module, the Pharmacy Management module, the Equipment Exchange module, and the Electronic Forms module.
